(19) United States
(12) Patent Application Publication
(10) Pub. No.: US 2012/0118144 A1
(43) Pub. Date: May 17, 2012

(54) Vacuum Chromatography Gas Detector

(75) Inventor: Marion H. Cates, (US)

(73) Assignee: MEADOWORKS, INC., Rupert, WV (US)

(21) Appl. No.: 12/944,722

(22) Filed: Nov. 12, 2010

(51) Int. Cl. B01D 53/02; G01N 30/02

(52) U.S. Cl. 95/19; 96/103; 96/102; 702/24

(57) ABSTRACT

A portable gas chromatography system and method of use. The portable gas chromatograph may be used to accurately and rapidly detect low-level concentrations of chemicals, such as fixed gases, volatilized liquid samples, or toxic chemicals and transmit to a user data relating to the presence and identity of such. The portable gas chromatograph uses an onboard vacuum source to pull samples into and through the system and thus does not require the use of a carrier gas. Further, the system comprises a solenoid valve for capturing the sample and may include a short porous layer open tubular separation column, and a thermal conductivity detector. Overall size and weight of the system is small enough for a user to carry. The method of operation of the gas chromatograph includes taking rapid successive samples and analyzing the data outputs using Fourier transform techniques. Such analysis allows real-time data updates and rapid detection of hazardous environmental agents.

### CROSS-REFERENCE TO RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### INCORPORATION-BY-REFERENCE OF MATERIAL ON DISC

Not Applicable

### BACKGROUND

1. Technical Field of the Invention

This invention pertains generally to a portable gas chromatography system and method which can accurately and rapidly detect low-level concentrations of fixed gases, volatilized liquid samples, or toxic chemicals and transmit to a user data relating to the presence and identity of such. More specifically, the disclosure contained herein provides a portable gas chromatography system which uses an onboard vacuum source to pull samples into and through the system and does not require the use of a carrier gas. Further, the disclosure provides a method for operation of the system which includes taking rapid successive samples and analyzing the data outputs using Fourier transform techniques.

2. Background of the Invention

Gas chromatography is an invaluable technique for the analysis of complex samples in both environmental and medical applications. As a practical matter, a gas chromatograph is an analytical instrument that separates a gaseous sample, or a liquid sample which has been converted to a gaseous state, into individual compounds so that these individual compounds can be readily identified and quantified. FIG. 1 is a schematic diagram of a standard gas chromatograph, which is generally designated by reference number 1. The standard gas chromatograph 1 includes an injector 4, a source of carrier gas 2 and a flow controller for that gas 3, an analytical separation column 5, a detector 7, and an output for displaying the results of the analysis 8.

The injector 4 functions to introduce a gaseous sample and moves the gaseous sample to the head of the separation column 5 in a narrow band. The separation column 5 is a cylinder or the like, packed or open tubular, that separates the sample into its individual components. Separation columns most commonly contain liquid or solid materials as a stationary phase, and separate the individual components based on their affinity for the medium, i.e. polar compounds have an affinity for a polar medium and non-polar compounds have an affinity for a non-polar medium, and their molecular weights as they are swept through the column by a carrier gas 2. Typically, the larger the molecule, the longer it is immobilized within the solid or liquid material within the separation column 5, and the longer it is retained on the column.

The carrier gas 2, most often helium, oxygen, nitrogen or hydrogen, is supplied from a large gas storage tank or a hydrogen generator, which produces hydrogen from pure deionized water. The carrier gas 2 flows through the injector 4 and pushes the constituent components of the sample onto and through the separation column 5.

The detector 7 then detects and measures the constituent components as they emerge from the separation column 5. Different sample components are retained for different lengths of time, i.e. “retention times”, within the separation column 5 and arrive at the detector 7 at characteristic times. These retention times are used to identify the particular sample components, and are a function of the type and amount of sorbtive material in the column, the column length and diameter, the carrier gas type and flow rate, and the column temperature. FIG. 2 is an exemplary chromatogram from a standard gas chromatograph.

Accurate temperature control is often an important factor in obtaining repeatable data. For precise work, the column temperature must be controlled to within tenths of a degree. Thus, typical gas chromatography systems place the separation column 5 in a well insulated, fan-forced, thermostat controlled oven 6. The oven 6 controls the temperature of the separation column 5, the optimum temperature being dependent upon the boiling point of the sample.

Gas chromatography is one of the most widely used and accurate methods for chemical identification. However, typical gas chromatographs employed in the laboratory setting are dimensionally large, heavy and are not easily transported for use in the field. Furthermore, they require a gas cylinder to supply the carrier gas. Such cylinders are also large and heavy, and the stored gas is under high pressure which poses a potential fire hazard for certain gases, i.e. hydrogen.

An additional disadvantage of current gas chromatographs is that they require significant analysis times. Such time requirements are imposed due to several factors. First, the use of long separation columns, i.e. greater than 50 meters, increases the time necessary for materials of interest to traverse the entire column. Long column lengths are traditionally necessary since the sample cannot be delivered at the entrance end of the column as a highly concentrated plug of material but rather is introduced over a significant time period. In order to provide acceptable definition in the separated mixture it is necessary to allow the sample to travel long distances along the separation column. This helps to reduce smearing of the constituent components and the consequent overlapping of peaks as they emerge from the separation column caused by differences in the time that portions of the analyte were introduced into the column. Second, the process of complete separation is significantly increased for some samples due to the presence of relativity high boiling point components which travel very slowly along the separation column. Although all of the significant information desired from the procedure might be obtained within a relatively short time period as the peaks of interest are generated in the chromatogram, it is necessary to wait for these higher boiling point components to be eluted from the column until the next sample can be introduced.

In recent years, the need for a portable, lightweight gas chromatography system capable of accurately and rapidly detecting low-levels of chemical agents has increased significantly. For example, the recent mining disasters in West Virginia at the Sago mine (2006) and in Naoma (2010) were responsible for 42 deaths. Both disasters have been attributed, in part, to high methane levels, a gas easily detected by gas chromatography. Furthermore, with the recent acts of global violence, there is great interest in the use of gas chromatography to detect chemicals which may be used in warfare or for terroristic activities.

Accordingly, there remains a need in the art for an improved, lightweight, portable gas chromatograph which can accurately and rapidly detect low-level concentrations of chemical and/or biological agents and transmit to user information pertaining to such samples.

The disclosure contained herein describes solutions to one or more of the problems described above.

### SUMMARY

A first embodiment of the present invention is directed to a portable gas chromatograph comprising a solenoid valve for permitting a gaseous sample to pass through a separator column in fluid communication with the solenoid valve, a sample component detector in fluid communication with the separator column, the sample component detector to detect constituent components of the gaseous sample as they emerge from the separation column, at least one of a vacuum chamber in fluid communication with the sample component detector and a vacuum pump in fluid communication with the vacuum chamber, and a controller. The controller of that embodiment includes a first input coupled to the sample component detector, a first output coupled to the solenoid valve, a second output coupled to the vacuum pump, and a processor coupled to the first input, first output, and second output. The processor includes instructions which, when executed by the processor, cause the processor to control operation of the solenoid valve, and control operation of the vacuum pump.

The first input of the controller may be coupled to the sample component detector, the first output of the controller may be coupled to the solenoid valve, and the second output of the controller may be coupled to the vacuum pump such that instructions executed by the processor cause the processor to control operation of the solenoid valve, and control operation of the vacuum pump.

In embodiments of the portable gas chromatograph, control of operation of the solenoid valve includes triggering opening and closing of the solenoid valve. Further, control of operation of the vacuum pump may include energizing and de-energizing or control of the speed of the vacuum pump. In embodiments, control of operation of the vacuum pump may include varying the flow capacity of the vacuum pump, varying the speed of the vacuum pump, and/or varying vanes associated with the vacuum pump.

Embodiments of the portable gas chromatograph may use a separator column which has a length of 5 to 30 centimeters and may be about 10 centimeters and a diameter of about 1 to 5 millimeters and may be about 2 millimeters. Further, the separator column may be a porous layer open tubular column. In certain embodiments, the porous layer of the porous layer open tubular column may be HaySep D.

Embodiments of the portable gas chromatograph may use a thermal conductivity detector as the sample component detector.

Embodiments of the portable gas chromatograph may further comprise a vacuum pressure gauge in fluid communication with the vacuum chamber and coupled to a second input of the controller, wherein the processor is coupled to the second input and further includes instructions which, when executed by the processor, cause the processor to control operation of the vacuum pump to create a desired pressure at the vacuum pressure gauge.

Embodiments of the portable gas chromatograph may further comprise a durable housing for enclosing the separator column, sample component detector, vacuum chamber, vacuum pump, first input, first output, second output, and processor.

Embodiments of the portable gas chromatograph may further comprise an atmospheric pressure gauge coupled to a third input of the controller, wherein the processor is coupled to the third input and further includes instructions which, when executed by the processor, cause the processor to control operation of the solenoid valve based on atmospheric pressure sensed by the atmospheric pressure gauge. In embodiments, control of operation of the solenoid valve may include varying the solenoid valve opening time or setting the solenoid valve orifice opening dimension.

Embodiments of the portable gas chromatograph may further comprise a power supply. The power supply may provide power to the controller, the solenoid valve, the sample component detector, and/or the vacuum pump. Further, the power supply may include at least one battery.

A second embodiment of the present invention is directed to a gas chromatography method for rapidly detecting gaseous compounds and informing a user about the existent of said gaseous compounds. The method may comprise querying an atmospheric pressure gauge, using a processor, to read an atmospheric pressure and opening a solenoid valve, using the processor, for a time interval calculated based on the atmospheric pressure to allow a defined quantity of sample to pass through the solenoid valve into a gas chromatography system. The defined quantity of sample may be a predetermined mass of sample and may be captured at a front end of a separation column using a vacuum applied in fluid communication with a downstream end of the separation column. Further, the defined quantity of sample may be drawn through the separation column using the internal vacuum, wherein constituent components of the sample separate during sample passage through the separation column. The constituent components of the sample are then passed through a detector, and the processor is used to analyze a data output from the detector for quantitation and identification of the constituent components of the sample.

Embodiments of the gas chromatography method may further comprise using the processor to query a vacuum pressure gauge for an internal vacuum pressure reading within the gas chromatography system, and control the internal vacuum pressure based on the internal vacuum pressure reading to create a steady internal vacuum pressure.

Embodiments of the gas chromatography method may further comprise querying the processor to determine if operation of the gas chromatography system should continue or cease, wherein continuation would indicate that successive samples are collected using each of the method steps for an additional cycle.

Embodiments of the gas chromatography method may further comprise using the processor to open the solenoid valve for an altered time interval, the altered time interval being a time interval different from the previous amount of time that the solenoid was opened and analyzing the data output from the detector during the altered time interval that the solenoid valve is open. The frequency of the altered time interval may be modulated.

In embodiments of the gas chromatography method, analysis of a data output from the detector for quantitation and identification of the constituent components of the sample may be performed using the processor which performs a Fourier transform on a time dependent data set.

In embodiments of the gas chromatography method, the separation column may be a porous layer open tubular column, wherein a porous layer of the porous layer open tubular column may be HaySep D. In additional embodiments, the detector may be a thermal conductivity detector or other detector applicable to the materials under analysis

### BRIEF DESCRIPTION OF THE DRAWINGS

Aspects, features, benefits and advantages of the embodiments herein will be apparent with regard to the following description, appended claims, and accompanying drawings, where:

FIG. 1 is a schematic block diagram of a gas chromatography system;

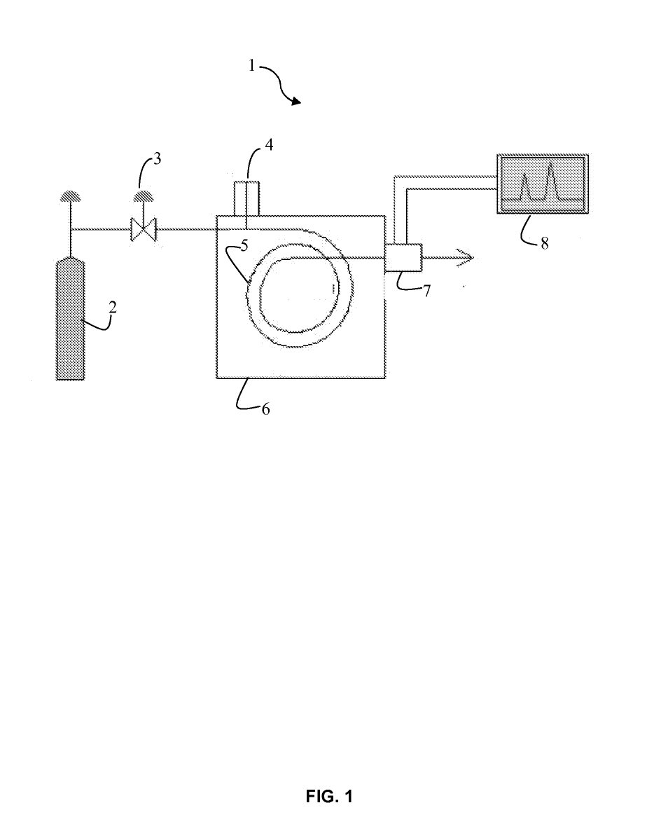

FIG. 2 is an exemplary chromatogram that may be obtained using a gas chromatography system such as the gas chromatography system of FIG. 1;

FIG. 3 is a schematic block diagram of one embodiment of a gas chromatography system according to the present invention;

FIG. 4 is an exemplary chromatogram that may be obtained using one embodiment of the system and method of the present invention;

FIG. 5 depicts an exemplary flow diagram describing one embodiment of a method of the present invention; and

FIG. 6 is an exemplary Fourier reconstruction of a gated chromatogram obtained using one embodiment of the system and method of the present invention.

### DETAILED DESCRIPTION

In the following description, the present invention is set forth in the context of various alternative embodiments and implementations involving a portable gas chromatography system and method for the rapid detection of chemical and/or biological agents in air samples. It will be appreciated that these embodiments and implementations are illustrative and various aspects of the invention may have applicability beyond the specifically described contexts. Furthermore, it is to be understood that these embodiments and implementations are not limited to the particular compositions, methodologies, or protocols described, as these may vary. The terminology used in the following description is for the purpose of illustrating the particular versions or embodiments only, and is not intended to limit their scope in the present disclosure which will be limited only by the appended claims.

Throughout the specification, reference to “one embodiment,” “an embodiment,” or “some embodiments” means that a particular described feature, structure, or characteristic is included in at least one embodiment. Thus appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

“Optional” or “optionally” means that the subsequently described event or circumstance may or may not occur, and that the description includes instances where the event occurs and instances where it does not. In addition, the word “comprising” as used herein means “including, but not limited to”. Throughout the specification of the application, various terms are used such as “primary”, “secondary”, “first”, “second”, and the like. These terms are words of convenience in order to distinguish between different elements, and such terms are not intended to be limiting as to how the different elements may be used.

While the term “sample” will be used in the disclosure below, “sample” will include reference to any bolus of liquid or gas introduced into the system of the present invention, either automatically or manually.

It must also be noted that as used herein and in the appended claims, the singular forms “a”, “an”, and “the” include the plural reference unless the context clearly dictates otherwise. Thus, for example, reference to a “gas” is a reference to one or more gases and equivalents thereof known to those skilled in the art, and so forth. Unless defined otherwise, all technical and scientific terms used herein have the same meanings as commonly understood by one of ordinary skill in the art.

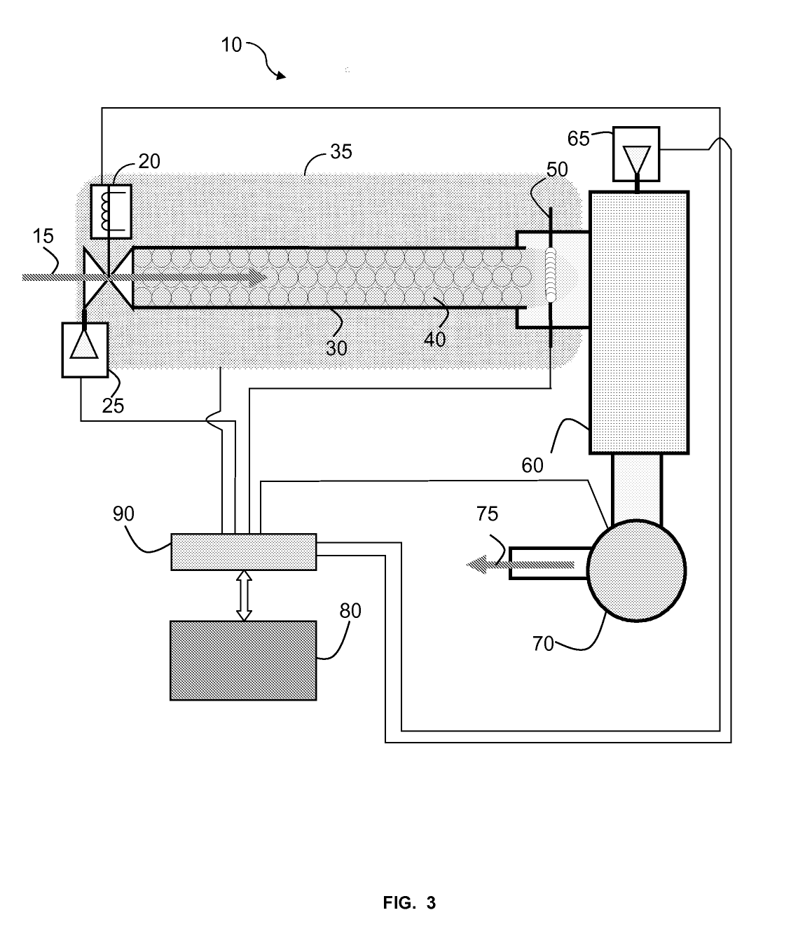

FIG. 3 provides a schematic view of the basic arrangement of a gas chromatography system according to one embodiment of the present invention, which is generally designated by reference number 10. As shown in the figure, this system includes a solenoid valve 20 which provides a means for introducing a sample onto a separation column 30. An arrow 15 indicates the flow path of the sample upon introduction into the gas chromatography system 10. The separation column 30 is fluidly connected to and downstream of the solenoid valve 20. The separation column 30 is also connected to and in fluid communication with a downstream detector 50, a vacuum chamber 60, and a vacuum pump 70. A thermoelectric heater/cooler 35 is included which may heat or cool any of the solenoid valve 20, the separation column 30, the detector 50, and/or the vacuum chamber 60. Any type of heater or cooler desired may be used in various embodiments and no heater or no cooler may be used in other embodiments. A second arrow 75 indicates the flow path of the sample as it exits the gas chromatography system 10. A computer 80 communicates with a controller device 90 which may control each of the solenoid valve 20, the detector 50, the vacuum pump 70, an atmospheric pressure gauge 25, and a vacuum chamber pressure gauge 65. Further, the computer 80 may provide signal processing to help resolve individual constituent components from one another and real-time data reduction using Fourier transform techniques. The computer 80 input and output signals and processing may all occur in real-time or near real-time.

The gas chromatography system 10 illustrated in FIG. 3 does not include a source of carrier gas, and thus does not use a carrier gas to push the sample onto or through the separation column 30. Rather, the sample may be pulled through the solenoid valve 20 and onto the separation column 30 using a vacuum pump 70 in combination with a vacuum chamber 60, or in other embodiments, using a vacuum pump 70 alone. In embodiments, the vacuum provided by the vacuum pump 70 and/or vacuum chamber 60 may also be used to pull the sample through the separation column 30. The vacuum chamber 60 may act as a vacuum reservoir in embodiments, providing an uninterrupted and relatively constant vacuum to the solenoid valve 20 and the separation column 30. The speed or other settings may be sent to the vacuum pump 70 from the computer 80 via signals sent from the controller 90. These settings may be based on pressure readings from the vacuum pressure gauge 65. The vacuum pump 70 and vacuum reservoir 60 provide a way to rapidly and consistently pull samples through the solenoid valve 20 and onto the separation column 30, and further may provide a means to pull constituent components of a sample through the separation column 30, thus reducing sampling times. In other embodiments, however, a vacuum pump 70 may be used alone to pull samples through the solenoid valve 20 and/or the separation column 30.

The separation column 30 of this embodiment may be only centimeters in length rather than the meters-long columns of the prior art. For example, in certain embodiments, the separation column 30 may be about three centimeters long to sense relatively small atoms and molecules, such as fixed gases like oxygen, nitrogen, hydrogen, carbon dioxide; and up to about thirty centimeters long to sense larger atoms and molecules, such as acetone, carbon tetrachloride, phosgene, benzene, etc. Further, the separation column 30 may have a diameter of between about half a millimeter to about three millimeters.

The separation column 30 may be a packed or open tubular column. In embodiments of the present invention, the separation column 30 may be a wall coated open tubular column (WCOT) or a porous layer open tubular column (PLOT). Such columns contain a thin coating of chemically bonded solid stationary phase on the inner walls, depicted as reference number 40 in FIG. 3. The solid stationary phase 40 may comprise any solid stationary phase known in the art including, but not limited to, molecular sieves such as metal aluminum silicates (e.g., molecular sieve 4A or 15A), porous polymers such as styrene cross-linked divinylbenzene (e.g., HaySep D), Teflon and even charcoal. Both molecular sieves and porous polymers have found considerable use in the separation of gaseous species such as the components of air, hydrogen sulfide, carbon disulfide, nitrogen oxides, and rare gases. In embodiments, the separation column 30 may be a WCOT column of about 10 cm in length and about 2 mm in diameter that is packed with a porous polymer such as HaySep D. Such a column may provide separation of fixed gases and volatile organics with molecular weights of less than 80 Daltons.

Other types of separation columns are envisioned by the present invention, and the choice of a solid stationary phase 40 is dictated, in large part, by the separation application for which the separation column is being used. The diameter and length of the separation column 30 and the solid stationary phase 40 film thickness that is selected will depend upon the type of sample being separated.

TABLE 1
Example solenoid valve opening times for a linear frequency scan

| Sampling | Cycle length | Valve open and closed |
|---|---|---|
| frequency (Hz) | (seconds) | time (seconds) |
| 0.5 | 2.000 | 1.000 |
| 1 | 1.000 | 0.500 |
| 2 | 0.500 | 0.250 |
| 3 | 0.333 | 0.167 |
| 4 | 0.250 | 0.125 |
| 5 | 0.200 | 0.100 |
| 6 | 0.167 | 0.083 |
| 7 | 0.143 | 0.071 |
| 8 | 0.125 | 0.063 |
| 9 | 0.111 | 0.056 |
| 10 | 0.100 | 0.050 |
| 11 | 0.091 | 0.045 |
| 12 | 0.083 | 0.042 |
| 13 | 0.077 | 0.038 |
| 14 | 0.071 | 0.036 |
| 15 | 0.067 | 0.033 |
| 16 | 0.063 | 0.031 |

The gas chromatography system 10 of the present invention may use a controller 90 to rapidly open and close the solenoid valve 20, allowing for rapid introduction of successive samples onto the separation column 30. Additionally, the controller 90 may be operated to open and close the solenoid valve 20 at a set frequency such as, for example, 1 Hz (i.e., the valve is open for half of a second at one second time intervals). This frequency may be constant or may be scanned (i.e., the frequency may be changed), such that the solenoid valve 20 open and closed times are changed with each sample intake. Table 1 lists solenoid valve opening times for a sample 0.5 Hz to 15 Hz linear frequency scan. The controller 90 may also be used to control the frequency of the solenoid valve 20 open and closed times in any user defined or programmed manner such as, for example, nonlinear or exponential.

The solenoid valve 20 receives control signals from the computer 80 via the controller 90. When energized, the solenoid valve (which is normally closed in this embodiment, but may be normally open if so desired) may open to allow a sample (e.g. air) to flow into the separation column 30. As described above, the solenoid valve 20 opening times may be constant or preset. An atmospheric pressure gauge 25 may be included to measure the atmospheric pressure of the sample just prior to entry into the gas chromatography system 10 via the solenoid valve 20. Pressure readings from the atmospheric pressure gauge 25 may be sent to the computer 80 via the controller 90 in such an embodiment. Based on these pressure readings, the solenoid valve 20 may be controlled to open for varied amounts of time, or to change the orifice size, to allow introduction of a known sample mass onto the separation column 30. Alternatively, pressure readings from the atmospheric pressure gauge 25 may allow the computer 80 to make concentration adjustments in the analyzed output provided to the user.

Embodiments of the gas chromatography system 10 may also comprise a sensor (not shown) for monitoring opening times for the solenoid valve 20. The sensor may, for example, be an LED/photodiode combination capable of measuring opening times for the solenoid valve 20 that are on the millisecond scale. Opening times measured by this sensor may be used to adjust future sampling times. In further embodiments of the gas chromatography system 10, the solenoid valve 20 may have a small internal volume in the region prior to sample entry to the separator column 30.

The gas chromatography system 10 of FIG. 3 also includes a heater/cooler 35, which may be used to maintain a constant temperature for the separation column 30. The heater/cooler 35 may be a thermoelectric device (i.e. Peltier device) that may heat or cool based on the polarity of the power supplied to the device. The heater/cooler 35 may be used to heat or cool the separation column 30 and the detector 50. In other embodiments, the heater/cooler 35 may be used to heat or cool any other component of the gas chromatography system 10 such as, for example, the solenoid valve 20 and/or the vacuum chamber 60.

The retention time of a constituent component from a sample can be highly temperature dependent. That is, small changes in temperature can cause significant shifts in the retention time of constituent components. For example, a 20° C. increase in column temperature can reduce retention times by as much as two-fold. While this may reduce detection times on the separation column 30, the identity of constituent components as they reach the detector 50 may be convoluted as the peaks become merged together. Thus, the selection of a separation temperature may involve a balance between detection speed and detection accuracy, and may depend upon the separation application for which the separation column is being used (i.e., stationary phase of the separation column, sample type and analysis parameters). For samples containing small molecular weight constituent components such as, for example, below 80 Daltons, the temperature may need to be maintained at or just above room temperature (i.e., about 100° F.). Much of the heating requirements for the separation column 30 and detector 50 may be provided by other components in the gas chromatography system 10 such as, for example, the heat generated by the vacuum pump 70. As such, in applications requiring low or near ambient temperature, the heater/cooler 35 may be used mainly as a cooler to maintain the low temperature.

The heater/cooler 35 may receive control signals from the computer 80 via the controller 90. These signals may include values set by the user during operation, or preset values stored in the computer 80 memory. Preset values may be related to the type of separation column 30 and/or detector 50 that are installed in the gas chromatography system 10 at the time of operation (see discussion elsewhere in this disclosure regarding embodiments comprising an analysis module).

In certain embodiments, high molecular weight components of a gaseous sample, i.e. greater than 80 g/mole, may require significant time intervals to exit the separation column 30, or may benefit from high column temperatures that reduce the resolution of the low molecular weight components. Additionally, these components may further reduce the resolution power of the solid stationary phase 40 of the separation column 30 as they frequently remain bound to the stationary phase. One solution is to trap the high molecular weight components on a pre-filter prior to sample entry onto the separation column 30. Thus, in embodiments of the present invention, a charcoal, Teflon or other desired type of pre-filter may be placed in fluid communication and downstream from the solenoid valve 20 and in fluid communication and upstream from the separation column 30. In those or other embodiments, a charcoal, Teflon or other desired type of pre-filter may be placed in fluid communication and upstream from the solenoid valve 20.

The gas chromatography system 10 of the present invention may also include a detector 50, which may be any of various types of detectors known in the art. In particular, suitable detectors include, without limitation, photo ionization, electron capture, nitrogen phosphorus, thermal conductivity, mass spectrometer, ion mobility spectrometer, or spectrographic. Selection of the type of detector to use in the gas chromatography system 10 may depend on the type of sample being probed. For example, a thermal conductivity detector may be used to detect virtually every compound, while photo ionization detectors may be used to detect aromatic compounds found in petroleum products, and photo-ionization detectors may be used to detect hydrocarbons and solvents. For military applications, such as explosive analysis in the field, a thermo ionic detector may be useful, or for detection of nerve gases, a nitrogen phosphorus detector.

As mentioned elsewhere in this disclosure, embodiments of the gas chromatography system 10 may include an internal analysis module which comprises at least the separation column 30 and the detector 50. This module may be easily exchanged during operation of the system, such that various combinations of separation columns and detectors may be included to allow for detection of a broad range of chemical species. Exchange of the analysis module may be automatically recognized by the computer 80 through a marking such as, for example, a bar code, or may be user specified by input entered on an external keypad or screen.

In embodiments of the present invention, the detector 50 may be a thermal conductivity detector, or “hot wire” detector. Such detectors may be considered universal detectors because they respond to all compounds, i.e. they are relatively insensitive to the sample composition. This property allows a thermal conductivity detector to be used without calibration, as the concentration of a sample component may be estimated by the ratio of the component peak area to the area of all components in the sample. Further, the relative insensitivity of such a detector may aid in de-convolution and analysis of the separated sample components when using the Fourier transform techniques described above.

A thermal conductivity detector contains a filament that is heated by an electric current. The filament may have a diameter in the range of 10⁻⁶ meters and is preferably comprised of a material having a high thermal coefficient of resistance such as platinum or nickel. The detector 50 may also include a well under the filament so that the sample components surround the filament as they flow past the detector 50. The detector 50 may furthermore be of miniature size so as to minimize the size of the detector cavity in gas chromatography system 10 and to support high speed chromatographic analysis.

During operation, computer 80 and controller 90 may communicate with the detector 50 so that a current may be applied through the filament to maintain the filament at a constant resistance. As constituent components of the gaseous sample pass over and under or around the filament, heat generated by the filament is conducted to the passing component at a rate which corresponds to the thermal characteristics of the component. The rate of this thermal conduction would normally have a direct effect on the resistance of the filament. However, an electronic servo loop (not shown) may adjust the current to keep the resistance of the filament constant. The resulting measured change in supplied power may thus produce the chromatographic signal used to identify and quantify components of the sample.

During operation, computer 80 and controller 90 may communicate with the detector 50 so that analysis of the constituent components may occur only during the period of time that the solenoid valve is open. That is, controller 90 may be operated to open and close the solenoid valve 20 at a set frequency such as, for example, 1 Hz (i.e., the valve is open for half of a second at one second time intervals), and further to receive data from the detector 50 only during that same time interval. Thus, the solenoid valve 20 and the detector 50 may be gated simultaneously and with the same frequency. As discussed above, this frequency may be constant or may be scanned such that the solenoid valve 20 open and closed times and the detector 50 data receive times may be changed with each sample intake (see Table 1 for an example frequency sweep). The controller 90 may also be used to control the frequency of the solenoid valve 20 open and closed times and the detector 50 data receive times in any user defined or programmed manner such as, for example, nonlinear or exponential.

Embodiments of the gas chromatography system 10 of the present invention may be much smaller and lighter in weight than prior art systems. The reduced length of the separation column 30, removal of the need for a carrier gas, and use of a miniaturized detector 50 all aid in reducing the overall dimensions and weight of the system. In certain embodiments, the entire gas chromatography system 10 may fit in a case the size of a standard lunchbox. In embodiments, the case may have dimensions of about 4 inches by 8 inches by 10 inches. This allows a user to carry or wear the unit when entering an environment where the air quality may be dangerous. The elimination of a carrier gas is also beneficial in situations or environments where the carrier gas may be harmful or dangerous.

The case for the gas chromatography system 10 of the present invention may be hard sided and/or sealed to protect system components in harsh environments. Further, in embodiments, the case may be adapted so that a user may wear the gas chromatography system 10 on their back, carry the system over their shoulder, or otherwise attach the system in a manner that may allow the user hands free operation. In embodiments, all of the components may be enclosed within the case, or some may remain on the exterior of the case such as, for example, in a slot or exterior compartment. Batteries or a power cord for attachment to an external power supply provide examples of components that may be most conveniently housed on the exterior of the case. Further, a speaker or light which may act as an alarm to the user, a graphical display panel, a means to initiate operation of the system and/or interact with the system such as an on/off button or a keypad, and an output device such as a printer or a communications port may also be housed on the exterior of the case to provide easy viewing or access for the user.

Components used for analysis, such as the solenoid valve 20, the separation column 30, the heater/cooler 35, the detector 50, and/or the vacuum chamber 60, may be housed in a compartment (analysis module) of the case. This analysis module may be a sealed case with one inlet and one outlet that plugs in-line with the other components of the gas chromatography system 10 in the main case. Further, the analysis module may comprise contacts or ports that allow communication or connection with other components of the gas chromatography system 10, such as the controller 90, the computer 80, the vacuum pressure gauge 65, and/or the power source. In certain embodiments, the vacuum pressure gauge 65 may be included within the analysis module. Such an analysis module may provide EMF protection for the internal components, and may be easily exchanged by a user for analysis of different ranges of chemicals, or if the system becomes contaminated (e.g., by ingestion of liquids).

Embodiments of gas chromatography system 10 of the present invention may be powered by a battery or a line voltage (i.e., 120 VAC or 240 VAC) alone, by a battery in combination with an external power supply (i.e., power cord with an external AC-DC converter to connect to an NC line), or another desired power source. In the battery and external power supply combination arrangement, the gas chromatography system 10 may be designed to sense whether the power source is the battery or AC line current and adjust itself appropriately. In certain embodiments, battery change-out or hot-swap may be accomplished without loss of instrument operation, with battery charging done off-line.

As discussed above, several of the individual components of the gas chromatography system 10 may be micro-scale components, thus power requirements may be sufficiently small to allow battery operation for about eight hours. As such, the power supply may include or consist entirely of one or more batteries. In embodiments, these batteries may be rechargeable batteries, for example, lithium thionel chloride batteries rated for high temperature environments, nickel cadmium batteries, or nickel metal hydride batteries.

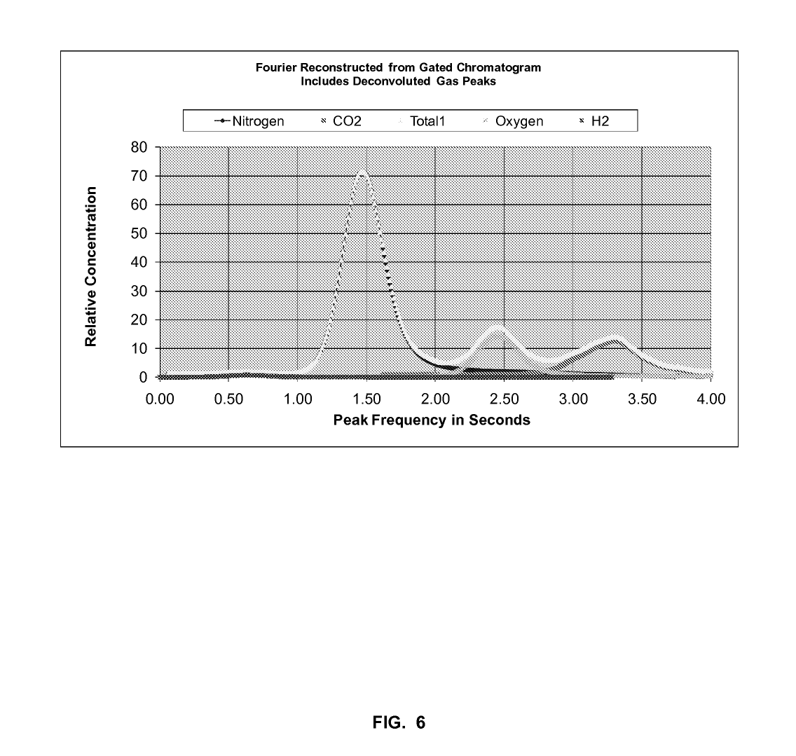

Sample reporting from the computer 80 may be in the form of a graphically displayed output, wherein the display may show peaks of the constituent components, such as shown in FIG. 6, or simple identities and percentages measured in the local sample environment. Alternatively, or in combination with the graphical display, the output may be in the form of an alarm (sound, light or display) warning the user of increased levels of potentially hazardous sample components in the local sample environment, and/or a printer. Further, embodiments of the gas chromatography system 10 may also include a communications port such as, for example, a USB port or SIM card slot that may allow the used to upload or download information to the computer 80.

The combination of some or all of these elements in the gas chromatography system of the present invention provides a lightweight, portable gas chromatograph which can accurately and rapidly detect low-level concentrations of fixed atmospheric gases, toxic chemicals, or other chemicals of interest or regulatory need and transmit to a user data relating to the presence and identity of such.

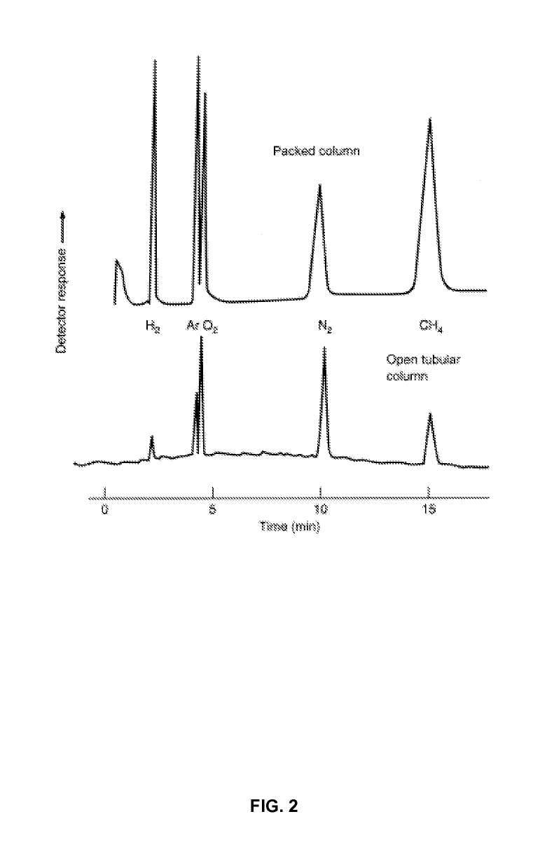

Chromatographic separation can be a rate-limiting step for gas chromatography systems, as described in the background section of this disclosure. The exemplary chromatogram shown in FIG. 2 demonstrates that full separation of the constituent components of a sample in a certain system may require at least 15 minutes. Thus, a second sample could not be introduced to the system prior to that 15 minute mark without overlapping the individual constituent component peaks. Embodiments of the present invention reduce the sampling time by rapidly and serially capturing samples using the solenoid valve 20 and processing signals received from the detector 50 only during the time frame that the solenoid valve 20 is open. That is, when the solenoid valve 20 is open, data is collected at the detector 50. When the solenoid valve 20 is closed, no data is collected at the detector 50. The data collection from the detector 50 may be done electronically by the controller 90 and computer 80, which select data only during the time when the solenoid valve 20 is open.

This method of sampling and detection allows for collection of a time dependent data set through processing using Fourier transform techniques. That is, given a data set collected over a specific frequency domain, Fourier transform techniques allow for conversion from the frequency domain to the time domain. Thus, since a given sample may be processed closer in time to the preceding and successive samples, the overall sample-throughput may be improved. More specifically, a plurality of samples may be characterized by detecting at least one component of a first sample, whereupon a second sample is captured through the solenoid valve 20 at a predetermined time interval. At least one component of the second sample may then be detected, whereupon a third sample is captured through the solenoid valve 20 at the predetermined time interval.

This process of detection and re-sampling may continue for any length of time, with a predetermined time interval of as little as one millisecond or less. The frequency of the time interval may also be changed, such as shown for a linear frequency sweep in Table 1. The computer 80 may be programmed to control the frequency sweep, wherein the frequency range may be set according to parameters needed for the gases being sampled. Further, in some embodiments, the predetermined time interval may be less than the time required to detect at least one component of each sample. Thus, the later-eluting components of the first sample may be present in the detection peaks of components from the second sample.

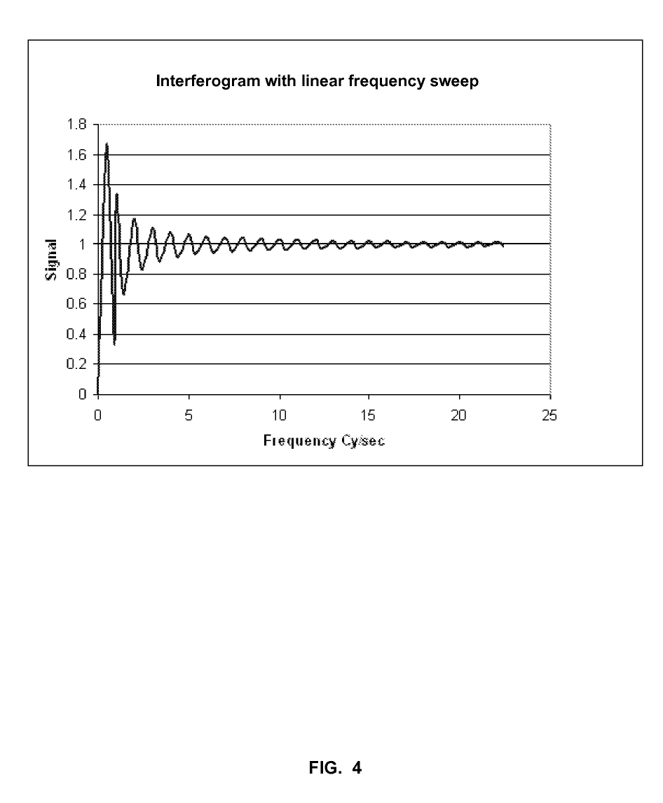

An exemplary chromatogram for capturing samples using a linear frequency sweep as listed in Table 1 is depicted in FIG. 4. In this chromatogram, peaks appear with a frequency similar to that of the frequency cycle listed in Table 1. Since individual samples may be introduced at fixed frequency swept intervals, the chromatogram in FIG. 4 may be mathematically converted from the frequency based chromatogram shown to a time based chromatogram using Fourier transform techniques. The time based chromatogram may then be updated in real-time at a predetermined time interval, thus showing all components which change at intervals lagging by the frequency of travel through the separation column 30. Such a chromatogram may look similar to the chromatogram of FIG. 2, but be updated more rapidly. An exemplary Fourier reconstruction of a gated chromatogram obtained using one embodiment of the present invention is shown in FIG. 6.

Although the method of data analysis has thus far been described in terms of the use of Fourier transform techniques, several other mathematical transforms may be used to convert the frequency domain output into a time domain output. In particular, a Laplace transform or Walsh transform may be used in embodiments of the present invention.

Capturing samples at short time intervals may introduce a large volume of material to the separation column 30. When using the gas chromatography system 10 of the present invention to measure air samples, for example, the major constituent of the samples, nitrogen at 78%, may act as a carrier gas, thereby negating the need for the addition of a carrier gas to the samples. (It may be noted that nitrogen is a chemically inert gas commonly used as a carrier gas in prior art systems.) Thus, the nitrogen from successively captured air samples may act as a traditional carrier gas and may aid in forcing the higher molecular weight components of the air samples through the separation column 30 at a faster rate. Thus, nitrogen or another component of the sample may act to carry compounds through the separation column 30 and may further reduce the sampling time interval while aiding in resolution of the individual sample components. The theoretical model used to analyze diffusion times on the separation column 30 may be changed by this carrier gas effect. For example, the fast diffusion of hydrogen in a sample of air may slightly speed up other gases. The amount of change can be used to predict or confirm the amount of hydrogen in the sample. Thus, the computer 80 may be used to model observed changes in the diffusion times of compounds on the separation column 30 using, as example, a mathematical matrix.

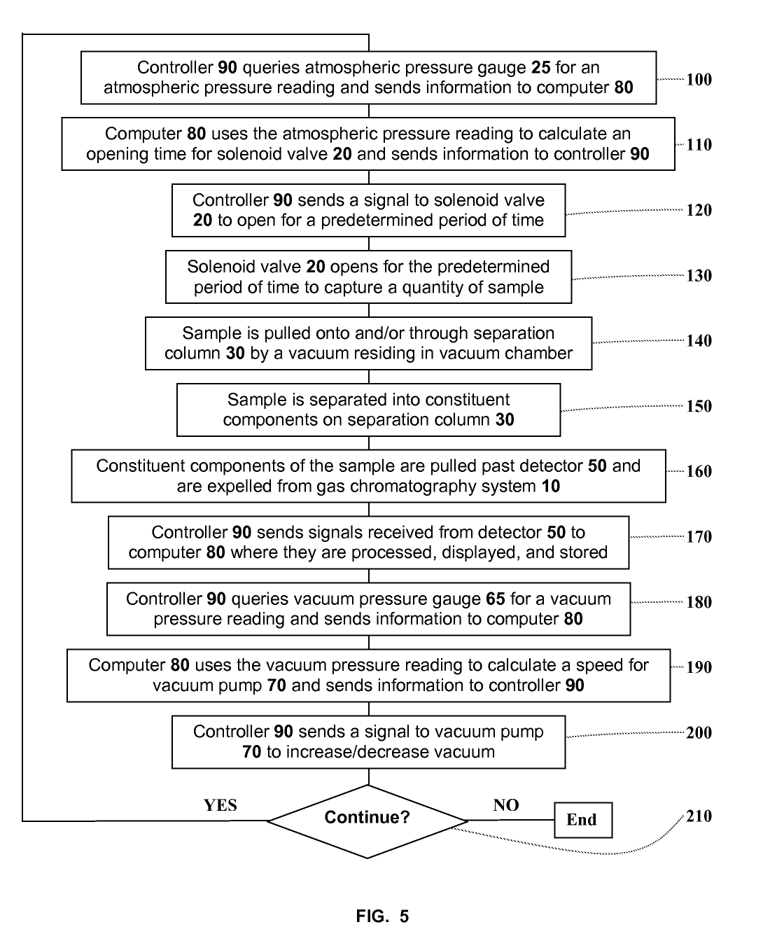

The basic operation of gas chromatography system 10 is depicted in the exemplary flow diagram of FIG. 5. The system controller 90 may query the atmospheric pressure gauge 25 for an atmospheric pressure reading. This reading is sent from the controller 90 to the computer 80 (100). The computer 80 may use the atmospheric pressure reading to calculate and control opening times for the solenoid valve 20, and possibly to change the size of the solenoid valve 20 orifice. The opening time or change in orifice size for the solenoid valve 20 may be determined to allow a desired mass of sample to enter gas chromatography system 10. The mass of the sample entering the gas chromatography system 10 may be varied manually by the user or may be varied automatically by the computer 80 based on stored preset conditions.

A signal is next sent from the computer 80 to the controller 90 relaying the calculated opening time and orifice size for the solenoid valve 20 (110). In other embodiments of the gas chromatography system 10, the opening times and orifice size for the solenoid valve 20 may be held at constant preset values (as discussed elsewhere in this disclosure), and the reading from the atmospheric pressure gauge 25 may be used to calculate the mass of sample that will enter the separation column 30. Thus, changes in the atmospheric pressure may be reflected in changes in the mass of sample introduced to the separation column 30, and the computer 80 may adjustments for the varied sample volumes during sample analysis.

The controller 90 then sends a signal to the solenoid valve 20 to open, and possibly change the orifice size, for the calculated amount of time (120). The solenoid valve 20 may open allowing capture of a quantity of sample (130). The quantity of sample is pulled onto and/or through the separation column 30 by the vacuum residing in the vacuum chamber 60 (140). The sample may then be separated into constituent components on the separation column 30, aided by the solid stationary phase 40 (150). The separated constituent components of the sample may then be pulled past the detector 50 by the vacuum residing in the vacuum chamber 60, or may pass the detector 50 by diffusion alone. These separated constituent components are then expelled from the gas chromatography system 10 at a point downstream from the vacuum pump 70 (160).

The controller 90 may also send signals received from the detector 50 to the computer 80 where they can be processed, displayed and/or stored (170). The computer 80 may provide signal processing to help resolve constituent components from one another and real-time data reduction using Fourier transform techniques. These signals may be sent from the detector 50 to the controller 90 at a specified time interval or continuously. Furthermore, the signals sent from the controller 90 to the computer 80 may also be at a specified time interval or may be continuous. The choice of signal sampling time may be based on several factors including, but not limited to, a desired data resolution level, data file size limits on the computer 80, the level of sample complexity, the type of sample, and the sample capture rate (set at 110).

The controller 90 may query the vacuum pressure gauge 65 for a vacuum pressure reading from the vacuum chamber 60 (180). The timed opening of the solenoid valve 20 may reduce the applied vacuum within the gas chromatography system 10, especially if the timed openings are for long periods or occur in rapid succession. While the vacuum chamber 60 may help to reduce or remove fluctuations in the vacuum pressure applied at the solenoid valve 20 and/or across the separation column 30, the vacuum pump 70 may be signaled to increase or decrease pumping speed in order to normalize the overall system pressure. Thus, the vacuum pressure reading may be sent to the computer 80 (180), and the computer 80 may use the reading to calculate an operating level (e.g., speed or frequency of operation) for the vacuum pump 70 and send that signal back to the controller 90 (190). The controller 90 may then send a signal to the vacuum pump 70 to increase or decrease the pumping operating level (200).

The computer 80 may be queried regarding whether to capture additional samples (210). If additional samples are to be captured, the computer 80 may send a signal to the controller 90 to reinitiate the sampling process (100). The controller 90 may be operated to open and close the solenoid valve 20 at a set frequency as described elsewhere in this disclosure. This frequency may be constant or may be scanned such that the solenoid valve 20 open and closed times are changed with each sample intake (refer to Table 1 for example solenoid valve opening times).

The system and method of the present invention offer several advantages. In particular, the system and method allow for sensitive quantitative determination of the concentrations of constituent components in a separated sample on a time interval much shorter than normally required to completely separate the constituent components. This allows samples to be analyzed rapidly and data to be reported to a user in near real-time. Further, the entire system size and weight has been reduced so that it may fit in a case the size of a lunchbox. This allows a user to carry or wear the unit when entering an environment where the air quality may be dangerous, providing a greatly increased level of protection against airborne hazards.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A portable gas chromatograph comprising:
a solenoid valve;
a separator column in fluid communication with the solenoid valve;
a sample component detector in fluid communication with the separator column, the sample component detector to detect constituent components of a gaseous sample as they emerge from the separation column;
a vacuum pump in fluid communication with the vacuum chamber; and
a controller, having:
a first input coupled to the sample component detector;
a first output coupled to the solenoid valve;
a second output coupled to the vacuum pump; and
a processor coupled to the first input, first output, and second output, the processor including instructions which, when executed by the processor, cause the processor to:
control operation of the solenoid valve, and
control operation of the vacuum pump.

2. The portable gas chromatograph of claim 1, wherein the separator column has a length of not more than 30 centimeters and a diameter of about not more than 5 millimeters.

3. The portable gas chromatograph of claim 1, wherein the control of operation of the solenoid valve includes triggering opening and closing of the solenoid valve.

4. The portable gas chromatograph of claim 1, wherein the control of operation of the vacuum pump includes energizing and de-energizing the vacuum pump.

5. The portable gas chromatograph of claim 1, further comprising a vacuum chamber in fluid communication with the sample component detector and the vacuum pump.

6. The portable gas chromatograph of claim 1, wherein the control of operation of the vacuum pump includes varying the speed of the vacuum pump.

7. The portable gas chromatograph of claim 1, wherein the control of operation of the vacuum pump includes varying vanes associated with the vacuum pump.

8. The portable gas chromatograph of claim 1, further comprising:
a vacuum pressure gauge in fluid communication with the vacuum chamber and coupled to a second input of the controller,
wherein the processor is coupled to the second input and further includes instructions which, when executed by the processor, cause the processor to control operation of the vacuum pump to create a desired pressure at the vacuum pressure gauge.

10. The portable gas chromatograph of claim 1, further comprising:
an atmospheric pressure gauge coupled to a third input of the controller,
wherein the processor is coupled to the third input of the controller and the processor further includes instructions which, when executed by the processor, cause the processor to control operation of the solenoid valve based on atmospheric pressure sensed by the atmospheric pressure gauge.

11. The portable gas chromatograph of claim 10, wherein the control of operation of the solenoid valve includes at least one of setting an opening time and setting an orifice opening dimension for the solenoid valve.

12. The portable gas chromatograph of claim 1, wherein the separator column is a porous layer open tubular column.

13. The portable gas chromatograph of claim 12, wherein a porous layer of the porous layer open tubular column is HaySep D.

14. The portable gas chromatograph of claim 1, wherein the sample component detector is a thermal conductivity detector.

15. The portable gas chromatograph of claim 1, further comprising a power supply providing power to at least the controller.

16. The portable gas chromatograph of claim 15, wherein the power supply further provides power to the solenoid valve, the sample component detector, and the vacuum pump.

17. The portable gas chromatograph of claim 15, wherein the power supply includes at least one battery.

18. A gas chromatography method for detecting gaseous compounds and informing a user about the existent of said gaseous compounds, the method comprising:
querying an atmospheric pressure gauge, using a processor, to read an atmospheric pressure;
opening a solenoid valve, using the processor, for a time interval calculated based on the atmospheric pressure to allow a defined quantity of sample to pass through the solenoid valve into a gas chromatography system;
capturing the defined quantity of sample at a front end of a separation column using an internal vacuum in fluid communication with a downstream end of the separation column;
drawing the defined quantity of sample through the separation column using the internal vacuum, wherein constituent components of the sample separate during sample passage through the separation column;
passing the constituent components of the sample through a detector; and
analyzing, using the processor, a data output from the detector for quantitation and identification of the constituent components of the sample.

19. The gas chromatography method of claim 18, further comprising:
querying, using the processor, a vacuum pressure gauge for a vacuum pressure within said gas chromatography system; and
controlling the internal vacuum pressure, using the processor, based on the internal vacuum pressure reading to create a steady internal vacuum pressure.

20. The gas chromatography method of claim 18, further comprising:
querying the processor to determine if operation of the gas chromatography system should continue or cease, wherein continuation would indicate that successive samples are collected using each of the method steps for an additional cycle.

21. The gas chromatography method of claim 20, further comprising:
opening the solenoid valve, using the processor, for an altered time interval; and
analyzing, using the processor, the data output from the detector during the altered time interval that the solenoid valve is open.

22. The gas chromatography method of claim 21, further comprising:
modulating the frequency at which the time interval is altered.

23. The gas chromatography method of claim 18, wherein said analyzing a data output from the detector for quantitation and identification of the constituent components of the sample is performed using the processor which performs a Fourier transform on a time dependent data set.

24. The gas chromatography method of claim 18, wherein the separation column is a porous layer open tubular column.

25. The gas chromatography method of claim 18, wherein the detector is a thermal conductivity detector.
